(19) United States
(12) Patent Application Publication
(10) Pub. No.: US 2018/0205685 A1
(43) Pub. Date: Jul. 19, 2018

(54) Dynamic Location Based Configuration of a Presentation

(71) Applicant: International Business Machines Corporation, Armonk, NY (US)

(72) Inventors: Inseok Hwang, Austin, TX (US); Su Liu, Austin, TX (US); Eric J. Rozner, Austin, TX (US); Chin Ngai Sze, Austin, TX (US)

(73) Assignee: International Business Machines Corporation, Armonk, NY (US)

(21) Appl. No.: 15/405,400

(22) Filed: Jan. 13, 2017

(51) Int. Cl. H04L 12/58; H04L 29/08

(52) U.S. Cl. CPC H04L 51/12; H04L 51/18; H04L 51/04; H04L 67/18

(57) ABSTRACT

Dynamic configuration of the presentation of a message system is provided. The dynamic configuration of the presentation of the message system occurs in response to a detected condition on the device. The geographic location of the device is extracted and compared to rules in order to identify a matching rule. The matching rule is dynamically applied to the presentation of data presented on the visual display operatively coupled to the device. More specifically, an arrangement of messages is generated and presented on the visual display.

### BACKGROUND

The present embodiments relate to dynamic location based configuration of a presentation. More specifically, the embodiments relate to dynamically configuring a presentation of a message system based on a geographic location.

Text based communication has become commonplace and comes in different forms, including electronic mail (email), short message service (SMS), social media, or other messaging system that are used to communicate. Message systems are utilized in order to compose, send, retrieve, and view messages. The message systems facilitate communication of information such as informal conversations and/or business transactions. These communication portals may be accessed by a variety of devices including desktop computers and portable devices such as laptops and mobile phones. Accessing one of these communication portals includes presenting messages on a visual display associated with the accessing device. It is understood that the presentation of messages on any visual display is an inherent security risk.

Web-based electronic mail is available for use online through a web browser or other application which may be downloaded to a client device. The electronic communication can be stored in a server, such as a cloud server, and may be downloaded to a client device. Regardless of the format of the electronic communication, all formats of presentation of the communication are subject to a security breach.

### SUMMARY

A system, computer program product, and method are provided to dynamically configure presentation of a message system based on location.

In one aspect, a system is provided with a device having a processing unit in communication with memory. The device receives at least one electronic communication for presentation on a visual display operatively coupled to the device. At least one geographic location rule is provided for configuring data. Each rule has one or more parameters related to the presentation of electronic communications on the visual display. A functional unit is in communication with the processing unit for dynamically configuring data presented on the visual display. More specifically, the functional unit detects a condition change local to the device. In response to the detected condition change, a geographic location from the device is identified including extraction of the geographic location from a service local to the device. A matching geographic location rule is identified. The functional unit dynamically applies the matching rule to data presented on the visual display utilizing at least one parameter of the matching rule. The dynamic application includes generation of an arrangement of one or more electronic communications. The arrangement of electronic communications is presented on the visual display.

In another aspect, a computer program product is provided for dynamic filtering and configuring of received data. The computer program product includes a computer readable storage medium with embodied program code that is configured to be executed by a processing unit. More specifically, program code detects a condition change local to a device. The device receives at least one electronic communication for presentation on a visual display operatively coupled to the device. In response to the detected condition change, program code identifies a geographic location of the device including extraction of the geographic location from a service local to the device. Program code identifies a matching rule from at least one geographical location rule. Each rule has one or more parameters related to the presentation of electronic communications on the visual display. Program code dynamically applies the matching rule to data presented on the visual display utilizing at least one parameter of the matching rule. The dynamic application includes generation of an arrangement of one or more electronic communications. Program code presents the generated arrangement on the visual display.

In yet another aspect, a method is provided for dynamic filtering and configuring of received data. A condition change local to a device is detected by a processor. The device receives at least one electronic communication for presentation on a visual display operatively coupled to the device. In response to the detected condition change, a geographic location is extracted from the device. A matching rule is identified from at least one geographic location rule. Each rule has one or more parameters related to the presentation of electronic communications on the visual display. The matching rule is dynamically applied utilizing at least one parameter of the matching rule. Application of the matching rule generates an arrangement of one or more electronic communications. The generated arrangement is presented on the visual display.

These and other features and advantages will become apparent from the following detailed description of the presently preferred embodiment(s), taken in conjunction with the accompanying drawings.

### BRIEF DESCRIPTION OF THE SEVERAL VIEWS OF THE DRAWINGS

The subject matter which is regarded as embodiments is particularly pointed out and distinctly claimed in the claims at the conclusion of the specification. The forgoing and other features, and advantages of the embodiments are apparent from the following detailed description taken in conjunction with the accompanying drawings in which:

FIG. 1 depicts a block diagram illustrating a computer system supporting dynamic configuration of the presentation of messages of a message system.

FIG. 2 depicts a flow chart illustrating a process for dynamic configuration of a presentation of a messaging system.

FIG. 3 depicts a flow chart illustrating a process for dynamic, real-time, rule generation for dynamic configuration of the presentation of a message system.

FIG. 4 depicts a flow chart illustrating a process for dynamic, real-time, rule generation utilizing machine learning.

FIG. 5 depicts a flow chart illustrating a process for manually defining rules.

FIGS. 6A-C depict a series of block diagrams illustrating an embodiment of a dynamic configuration of a message system.

FIG. 7 is a block diagram illustrating an example of a computer system/server of a cloud based support system, to implement the process described above with respect to FIGS. 1-6.

FIG. 8 depicts a block diagram illustrating a cloud computer environment.

FIG. 9 depicts a block diagram illustrating a set of functional abstraction model layers provided by the cloud computing environment.

### DETAILED DESCRIPTION

It will be readily understood that the components of the present embodiments, as generally described and illustrated in the Figures herein, may be arranged and designed in a wide variety of different configurations. Thus, the following detailed description of the embodiments of the apparatus, system, and method of the present embodiments, as presented in the Figures, is not intended to limit the scope of the embodiments, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiment of the present embodiments. Thus, appearances of the phrases “a select embodiment,” “in one embodiment,” or “in an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

Messages presented on the visual display of a client device may be audience sensitive. Portability of devices able to access message systems has led to users accessing message systems in areas with differing audiences. A user has to be cognizant of the messages displayed on a visual display and the audience that may be able to see the display of messages. In one embodiment, a message intended to be view only by the recipient, may be seen by an unintended audience. For instance, when a user is viewing an email system presented on the visual display of a client device (e.g. laptop) in an open area (e.g. coffee shop), an unintended entity (e.g. competitor) may also be able to view a particular message (e.g. trade secret) in the email system presented on the visual display. In another example, a user may be presenting a slide presentation to an audience (e.g. client) and needs to switch to a web browser to continue the presentation. A web-based email could already be opened in the browser and for a short period of time the audience is able to view an audience sensitive message (e.g. message to client's biggest competitor). The ease of use of the web-based email systems may increase the unintended disclosure of audience sensitive messages.

A system, method and computer program product are provided for dynamic configuration of the presentation of a message system. The dynamic reconfiguration can limit the unintended viewing of audience sensitive messages based on the geographic location of the device viewing the messages. The dynamic reconfiguration of the presentation of the message system occurs in response to a detected condition on the device. The condition may be, activating a web browser, focusing a web browser, focusing a tab of a web browser, or activating and/or focusing a message application. Similarly, in one embodiment, the condition may physically activate an application that was previously in a non-active state, e.g. sleep state or hibernate state. The geographic location of the device is extracted and compared to rules in order to identify a matching rule. The rule is dynamically applied to the presentation of the message system and a dynamically configured presentation is created. The dynamically configured presentation is presented on the visual display based on the rule. In one embodiment, the dynamically configured presentation limits the unintended viewing of audience sensitive messages based on the rule. In one embodiment, the dynamically configured presentation allows viewing of audience sensitive messages based on the rule. Accordingly, the dynamically configuration of the presentation of the message system is based on the geographic location of the device.

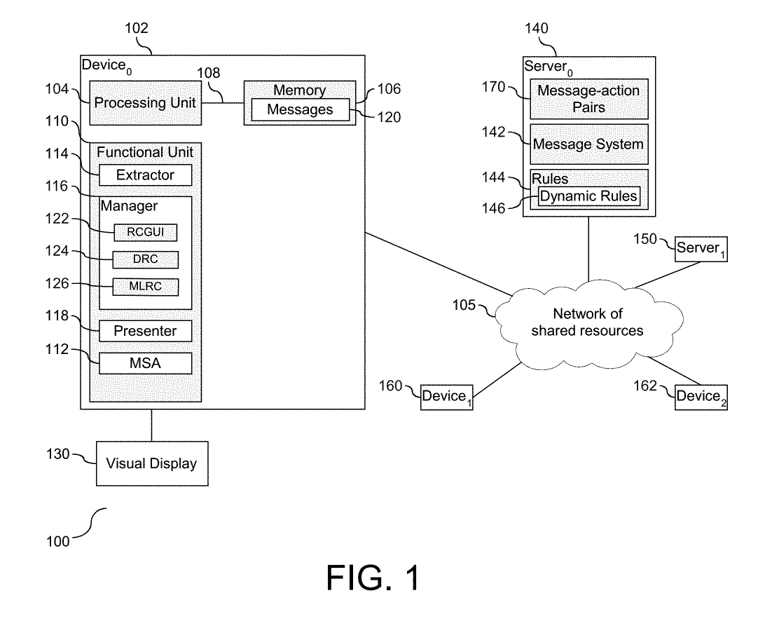

Referring to FIG. 1 a block diagram (100) is provided illustrating a computer system supporting dynamic configuration of the presentation of messages of a message system. As shown, client device₀ (102) is configured with a processor (104), also referred to herein as a processing unit, operatively coupled to memory (106) across a bus (108). Client device₀ (102) is configured in communication with a visual display (130). The client device₀ (102) is provided in communication with a network of shared resources (105). A plurality of servers, such as server₀ (140) and server₁ (150), and other client devices, such client device₁ (160) and client device₂ (162) as are provided in communication with the network of shared resources (105).

As shown, rules (144) are provided in order to support the dynamic configuration of the presentation of messages of a message system. Each rule present in the set of rule (144) has one or more associated parameters. The rule parameters may include, but are not limited to, a location, a message system identifier, a device identifier, an entity identifier, a display setting, a message filter setting, a message categorization setting, a memory configuration setting, and a processor configuration setting. In the example shown herein, rules (144) may be embedded in server₀ (140). In one embodiment, rules (144) may be embedded in client device₀ (102), and in one embodiment, rules (144) may be embedded in a shared resource (not shown). Client device₀ (102) is provided with a functional unit (110) in communication with the processor (104). Functional unit (110) contains tools to support dynamic configuration of the presentation of messages (120) of the message system (142), including but not limited to, message system accessor (MSA) (112), location extractor (114), dynamic configuration (DC) manager (116), and presenter (118). In one embodiment, a selection of the elements embedded in the functional unit may be embedded with server₀ (140), and available to any device in communication with server₀ (140). Accordingly, the embedded tools support the functionality associated with dynamic configuration of the presentation of messages of a message system.

Each of the tools embedded in the functional unit (110) contribute to the aspects of the dynamic configuration of the presentation of messages of a messaging system as described below. The MSA (112) accesses a message system, such as message system (142). In one embodiment, message system (142) is provided on server₀ (140). The MSA (112) can compose, send, retrieve, and view messages associated with message system (142). MSA (112) stores one or more messages (120) associated with message system (142) in memory (106). In one embodiment, the messages (120) are stored in cache memory (not shown). In one embodiment, the functionality of the MSA (112) and message system (142) are provided in a single location and/or module. The location of message system (142) should not be considered limiting.

The DC manager (116) detects a condition change local to client device₀ (102). The condition change can be, but is not limited to, activating a web browser, focusing a web browser, focusing a web browser tab, and activating a message application. A dynamic configuration of the presentation of messages (120) of the message system (142) on client device₀ (102) is performed in response to the condition change. In one embodiment, processor (104) and memory (106) are in a sleep state or hibernating state until they are activated by the detection of a condition change, with the activation of the processor (104) and/or memory (106) changing their respective utilization of resources associated with client device₀ (102). The location extractor (114) extracts a geographic location from client device₀ (102). The geographic location may be extracted from a location-based service utilizing a Global Positioning System (GPS), check-in reporting, control plane locating, Bluetooth, WLAN, infrared, RFID, IP address, digital map service, or other location technology. Accordingly, in response to a condition change detected by the DC manager (116), the location extractor (114) extracts a geographic location.

The configuration manager (116) compares the extracted geographic location to rules (144) and determines a matching rule. The DC manager (116) dynamically configures a presentation of messages (120) based on the matching rule for presentation on visual display (130). In one embodiment, the DC manager (116) physically modifies the configuration of memory (106) to physically restrict access to one or more of messages (120). In one embodiment, the dynamic configuration includes the DC manager (116) to extract information from message(s) (120) via parsing and scan the information for keywords and/or other data pertinent to application of the identified rule. The DC manager (116) flags messages with keywords and other data pertinent to application of the identified rule. In one embodiment, the flagging includes changing a byte associated with the message in memory (106). The DC manager (116) dynamically configures a presentation of message(s) (120) by creating a new presentation of message(s) (120) including only those non-flagged messages. In one embodiment, the DC manager (116) stores message(s) (120) in two different sectors of the memory (106), including a presentable sector for non-flagged messages and an unpresentable sector for flagged messages where hardware elements and program code are prevented from accessing the unpresentable sector.

The presenter (118) displays the dynamically configured presentation of message(s) (120) on visual display (130). In one embodiment, the presenter (118) only displays messages located in the presentable sector of memory (106) on visual display (130). In one embodiment, the presenter (118) does not have access to the unpresentable sector of memory (106). The presenter (118) dynamically updates the display of message(s) (120) on visual display (130) in response to an updated configuration of the presentation of message(s) (120) provided by DC manager (116). In one embodiment, the dynamically configured presentation of message(s) (120) is maintained even if the presentation is unfocused or minimized. The DC manager (116) dynamically applies the matching rule to any message received after the first application of the matching rule. In one embodiment, the dynamic configuration only occurs in response to a detected condition thereby minimizing the use of resources local to the client device₀ (104). Accordingly, the tools of functional unit (110) support dynamic configuration of the presentation of messages of a message system.

The DC manager (116) supports creation of one or more rules, such as rules (144). The DC manager (116) comprises a plurality of rule creating functionality, such as rule composition graphical user interface (RCGUI) (122), dynamic rule composer (DRC) (124), and machine learning rule composer (MLRC) (126). RCGUI (122) interfaces with client device₀ (102) in order to manually define one or more rules, such as rules (144). DRC (124) dynamically creates one or more rules, such as rules (144) based on a system condition change local to client device₀ (102). For example, DRC (124) utilizes one or more dynamic rules, such as dynamic rules (146) and the extracted geographic location and searches a corpus of learned data (not shown) for one or more entities that are proximal the extracted geographic location. Based on the one or more proximal entities and one or more dynamic rules from dynamic rules (146), a new rule is dynamically created and stored in rules (144). For example, company A is proximal the extracted location of client device₀ (102). Company B is company A's competitor. The utilized dynamic rule C (not shown) of dynamic rules (146) has a parameter to exclude competitors of entities local to the extracted location. Therefore, in this example new rule D is dynamically created to exclude company B when dynamically configuring a presentation of a message system and new rule D (not shown) is stored in rules (144).

The MLRC (126) dynamically learns new rules based on previous configurations of the presentation of message system (142) on client device (102), or in one embodiment any client device in communication with the message system (142). In one embodiment, the MLRC (126) may perform supervised learning, including the use of a set of cases, such as one or more message-action pairs (170), to train the system in order to generate a new rule. The new rule may be amended to the rules (144) and stored therein, or in one embodiment may be stored local to memory (106). The message-action pairs (170) may be stored in server₀ (140). In one embodiment, the message-action pairs are stored in a corpus (not shown) and may be shared between multiple client devices. The message-action pairs (170) include information such as, but not limited to, a message identifier, a geographic location, and an action performed at the location (e.g. change configuration, do not change configuration, and/or the type of configuration change). In one embodiment, the MLRC (126) passively operates in the background of client device₀ (102) to dynamically create and store a message-action pair which may be stored locally in memory (106) or in one embodiment server₀ (140) in message-action pairs (170). Accordingly, the MLRC (126) performs supervised learning utilizing stored message-action pairs (170) to dynamically create a new rule which can be utilized while configuring the display of similar message types or in order to determine configuration of a new or unknown message type.

The MLRC (126) may operate in a supervised learning mode, or in one embodiment, an unsupervised learning mode. For example, in one embodiment, the MLRC (126) may perform unsupervised learning to generate a set of new rules. When the MLRC (126) is activated in the unsupervised learning mode, the MLRC (126) detects, in real-time, changes to the configuration of the presentation of an associated message system, such as message system (142). The MLRC (126) identifies the detected change to the configuration. In response to the identification of the detected change, the extractor (114) extracts the geographic location of client device₀ (102). The MLRC (126) utilizes the identified change and extracted location to create a new rule. The new rule may be stored local to memory (106) or in one embodiment, in rules (144). Rules (144) may be applied to a client device, an account, a location, and/or generally to all presentations of a message system. Accordingly, rules are created and dynamically applied to the configuration of a message system based on one or more parameters associated with the rule.

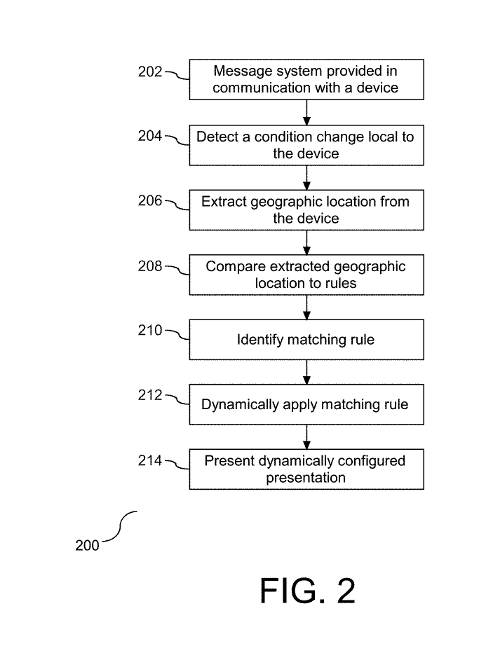

Referring to FIG. 2 a flow chart (200) is provided illustrating a process for dynamic configuration of a presentation of a messaging system. As shown, a message system is provided in communication with a device (202), such as client device₀ (102). A condition change local to the device is detected (204). In one embodiment, the detected condition change activates one or more hardware elements of the device that were in a sleep state, hibernate state, or some form of inactive state. The condition change may be, but is not limited to, activation of a web browser, focusing a web browser, focusing a web browser tab, and activation of a message application. In one embodiment, the condition change is a display of content of the message system. In response to the detected condition at step (204), a geographic location is extracted from the device (206). The extracted location may be extracted from a location based service local to the device.

The extracted location is compared to rules (208) and a matching rule is identified (210). The rules have one or more parameters that relate to the presentation of data on a visual display. The matching rule is dynamically applied to the presentation of a message system on the device (212). The dynamic application of the rule includes transforming a presentation of the message system based on the rule. For example, a first configuration of the presentation of the message system having a first arrangement of messages is transformed into a second configuration having a second arrangement of messages. The transformation includes selectively adding or removing messages to the first arrangement in order to create the second arrangement based on one or more parameters of the rule. In one embodiment, the first and second arrangements are different. After the dynamic application, the presentation of the message system is presented on the device including an arrangement of messages (214). Accordingly, the presentation of the message system on the device is dynamic and the presentation is configured or reconfigured in response to the detected condition change(s) on the device.

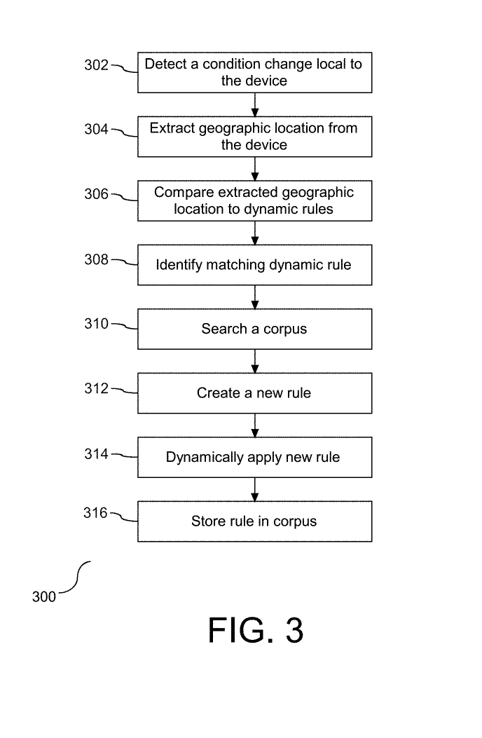

Referring to FIG. 3 a flow chart (300) is provided illustrating a process for dynamic, real-time, rule generation for dynamic configuration of the presentation of a message system. A condition change is detected local to a device (302). In response to the detected condition, a geographic location is extracted from the device (304). The extracted location is compared to dynamic rules (306) and a matching dynamic rule is identified (308). The dynamic rule includes parameters for creation of new rules. Based on the identified matching dynamic rule and the extracted geographic location, a corpus of learned data is searched for data related to the dynamic rule (310). Data related to the dynamic rule may be, but is not limited to, entities proximal to the extracted location and data associated with the entities. A new rule is created is at step (312), including transforming the extracted geographic location and data related to the dynamic rule into a new rule based on the parameters of the dynamic rule. The new rule is dynamically applied to the presentation of a message system (314). In one embodiment, the rule is stored in the corpus (316). Accordingly, new rules may be dynamically created.

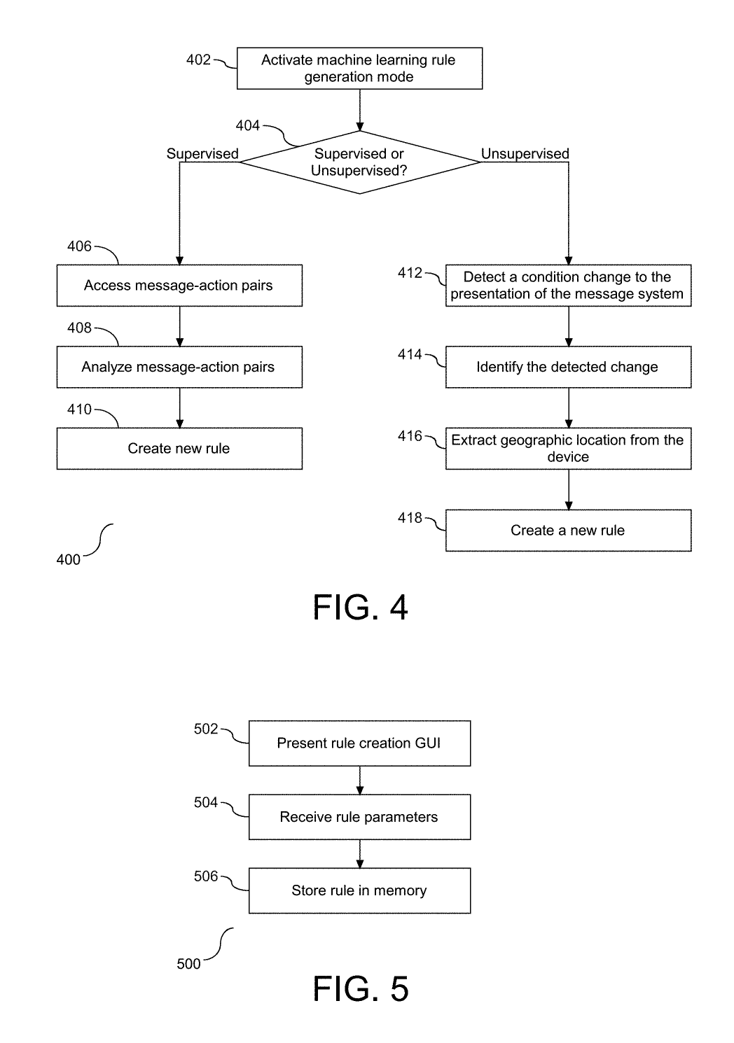

As described above, created rules may be dynamically applied to a client device. However, circumstances are subject to change, and the rules need to be responsive to such circumstances. Referring to FIG. 4, a flow chart (400) is provided illustrating a process for dynamic, real-time, rule generation utilizing machine learning. A rule generation mode utilizing machine learning is activated (402). As shown, either a supervised or an unsupervised learning mode is selected (404). In one embodiment, the learning mode selection is an automated response to a condition. Selection and/or activation of the supervised learning mode is shown at step (404) to facilitate and/or enable preparation of a new rule, and a set of cases including one or more message-action pairs are accessed (406). In one embodiment, a message-action pair may indicate to not perform a change to a display of a first particular type of message at an associated first location, and another message-action pair may indicate to perform a change to a display of a particular second type of message at the associated first location. After accessing the messages, the message-action pairs are analyzed (408) in order to train the machine learning system. The analysis includes comparing and contrasting the message-action pairs, including identifying similarities and differences between the message-action pairs. Based on the analysis, a new rule is created (410), including transforming the identified similarities and differences into one or more parameters of the new rule. In one embodiment, the rule parameters include, but are not limited to, a location associated with the rule, and one or more settings associated with the configuration of the presentation of a message system. In one embodiment, machine learning may utilize a plurality of different algorithms to generate a new rule. Accordingly, the supervised learning mode utilizes message-action pairs to generate one or more rules to handle other messages including similar types of messages and unknown types of messages.

As shown at step (404), in response to selection or activation of the unsupervised machine learning mode the process proceeds to step (412). In the unsupervised machine learning mode the machine learning dynamically learns new rules based on changes to configurations of the presentation of a message system on a device. As shown, one or more changes are detected, in real-time, to the configuration of the presentation of messages local to a device (412), such as client device₀ (102). In one embodiment, the detected changes are, but not limited to, removing/adding a message, removing/adding a portion of a message, and a format change of the display of a message. The detected change(s) to the configuration is identified (414). In response to the identification of the detected change, the geographic location of the device is extracted (416). A new rule is created at step (418), including transforming the identified change and extracted location into one or more parameters of the new rule. In one embodiment, the rule parameters include, but are not limited to, a location associated with the rule, and one or more settings associated with the configuration of the presentation of a message system. In one embodiment, the unsupervised learning mode stores the identified change, extracted location, and a message identifier as a message-action pair. In one embodiment, the unsupervised learning mode stores the extracted location, and a message identifier associated with an unchanged message as a message-action pair. Accordingly, machine learning can support the creation of new rules.

Rules may be created by selection of available defining parameters. In addition, rules may be manually created to define specific parameters. Referring to FIG. 5, a flow chart (500) is provided illustrating a process for manually defining rules. A rule creation graphical user interface (GUI) is presented on a device (502). The GUI receives rule parameters such as a location and parameters for presentation of a message system on a device at a specified location (504). Parameters for the rule may include, adding messages to a displayed arrangement or removing messages from a displayed arrangement based on sender, recipient, address of sender or recipient, subject, body of the message, or other message based criteria. After the rule and the associated parameters have been created and defined, the rule is stored in memory (506). In one embodiment, the user may define a selective application of the rule, e.g. which rules apply to which device. Accordingly, rules are manually defined.

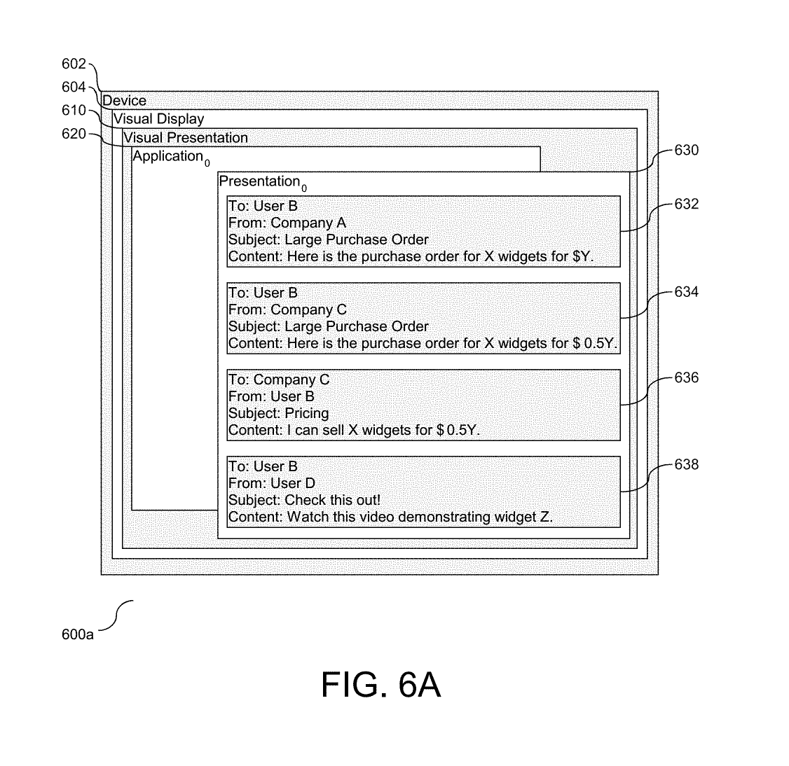

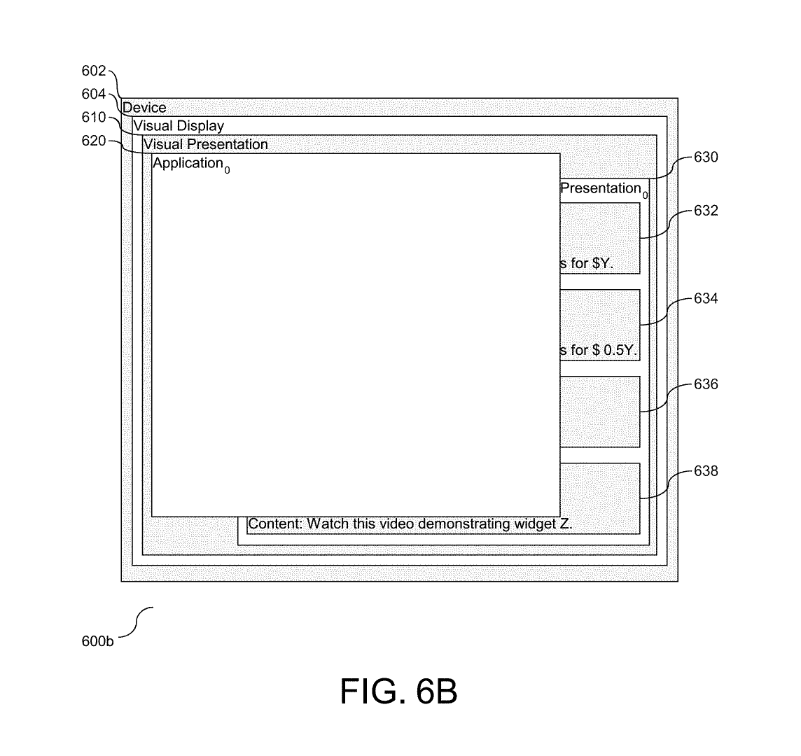

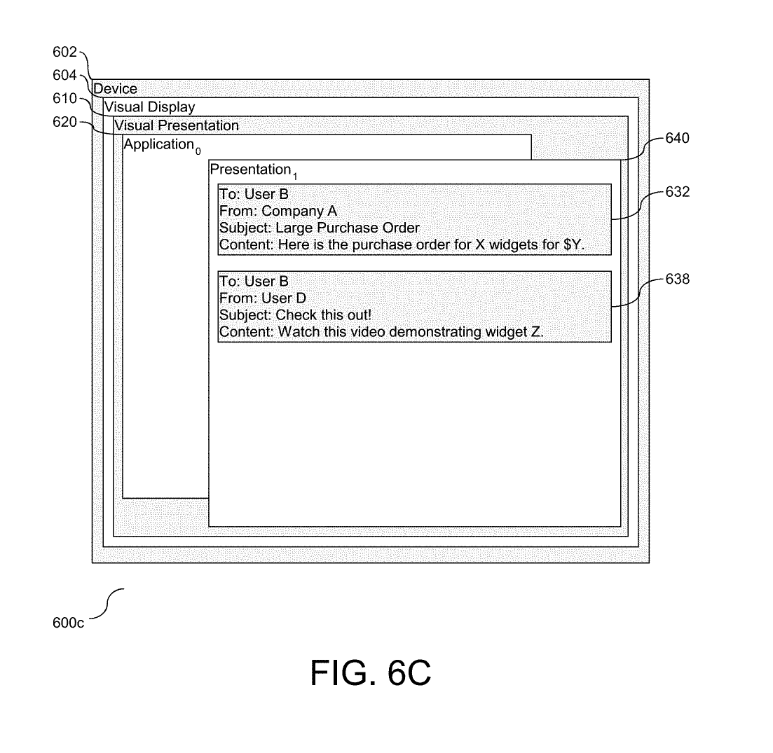

Referring to FIGS. 6A-C a series of block diagrams (600a-c) are provided illustrating an embodiment of dynamic configuration of a message system. As shown in FIG. 6A, a visual presentation (610) is presented on visual display (604) of a device (602). The visual presentation includes an unfocused first application, application₀, (620) and a focused first presentation, presentation₀, (630) of messages of a message system. Application₀ (620) is shown layered behind the focused presentation₀ (630) for illustration purposes only and should not be considered limiting. The focused presentation₀ (630) includes message (632) from Company A to User B, message (634) from Company C to User B, message (636) from User B to Company C, and message (638) from User D to User B. The parts of the messages shown are for illustration purposes and should not be considered limiting. Accordingly, a first presentation of the message system is presented on the visual display (604) of the device (602).

The visual presentation (610) is shown reconfigured in FIG. 6B. Application₀ (620) is focused and presentation₀ (630) of messages of the message system is shown unfocused. More specifically, messages (632)-(638) have been obscured due to the reconfiguration.

Referring to FIG. 6C, the visual presentation (610) shown on the visual display (604) of device (602) reconfigured from the configuration shown in FIG. 6B. The reconfiguration from the visual presentation (610) in FIG. 6B to the visual presentation (610) in FIG. 6C is detected as a change in condition causing a dynamic configuration of the presentation of the message system. The detected change designates the presentation₀ (630) of the messages of the message system to be focused. Before presentation₀ (630) was exhibited as focused on the visual display (604), presentation₀ (630) was dynamically configured. The dynamic configuration transforms presentation₀ (630) by removing messages (634)-(636) from the resentation₀ (630) to create a second presentation, presentation₁ (640) of the message system including messages (632) and (638). In one embodiment, the rule utilized in the dynamic reconfiguration removes a selection of messages, shown in this example as electronic mail messages associated with company B. Accordingly, the detected change causes a dynamic application of the rule to the presentation of a message system.

The dynamic reconfiguration of the presentation of the message system improves the security of a message system while maintaining accessibility of the message system. The dynamic reconfiguration of messages within the messaging system limits unintended audiences from viewing one or more messages. In one embodiment, the dynamic configuration only occurs in response to a detected condition change in order to minimize the resource consumption of a device, such as battery, bandwidth, processing time, etc. For example, in one embodiment, one or more hardware elements of a device in a resource minimizing state (e.g. sleep state or hibernate state) are activated by the detected condition change in order to perform the dynamic configuration such that the activated state of the one or more hardware elements utilizes more resources than the resource minimizing state.

In one embodiment, the message system is a web-based electronic mail system such as, but not limited to, Gmail, Hotmail, and IBM Verse. In one embodiment, the message system is an electronic mail application such as outlook, mail, or Gmail app.

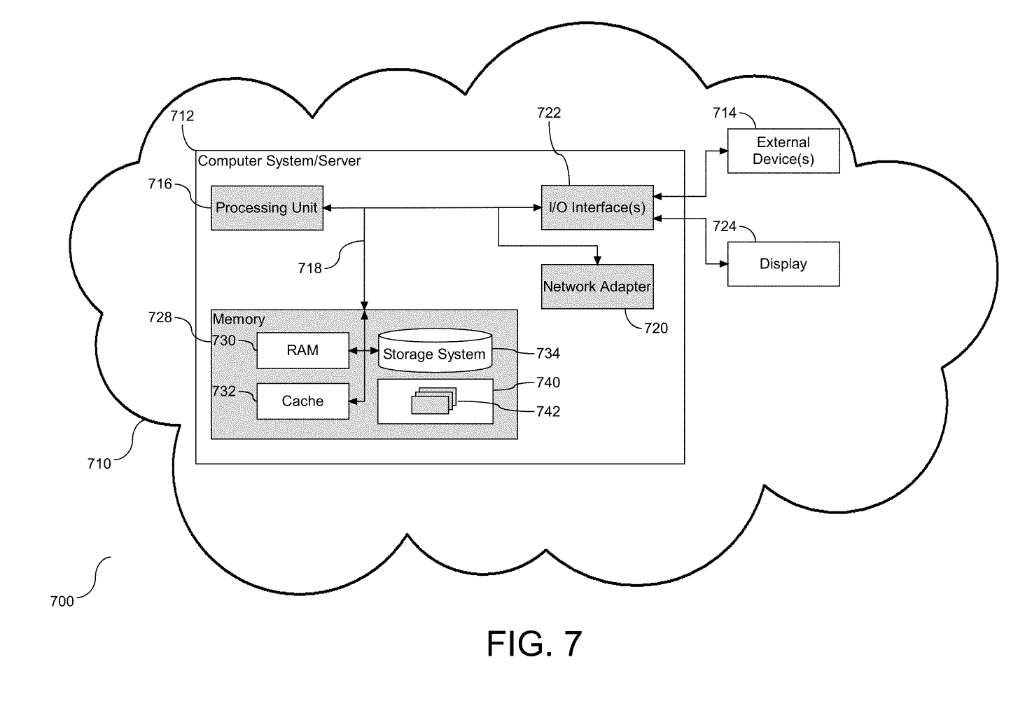

Aspects of dynamically configuring the presentation of a message system as shown in FIGS. 1-6C, employ one or more functional tools. Aspects of the functional tool, e.g. location extractor, dynamic configuration manager, message application accessor, and presenter, and its associated functionality may be embodied in a computer system/server in a single location, or in one embodiment, may be configured in a cloud based system sharing computing resources. With references to FIG. 7, a block diagram (700) is provided illustrating an example of a computer system/server (712), hereinafter referred to as a host (712) in communication with a cloud based support system, to implement the processes described above with respect to FIGS. 1-6C. Host (712) is operational with numerous other general purpose or special purpose computing system environments or configurations. Examples of well-known computing systems, environments, and/or configurations that may be suitable for use with host (712) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and file systems (e.g., distributed storage environments and distributed cloud computing environments) that include any of the above systems, devices, and their equivalents.

Host (712) may be described in the general context of computer system-executable instructions, such as program modules, being executed by a computer system. Generally, program modules may include routines, programs, objects, components, logic, data structures, and so on that perform particular tasks or implement particular abstract data types. Host (712) may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, host (712) is shown in the form of a general-purpose computing device. The components of host (712) may include, but are not limited to, one or more processors or processing units (716), a system memory (728), and a bus (718) that couples various system components including system memory (728) to processor (716). Bus (718) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Host (712) typically includes a variety of computer system readable media. Such media may be any available media that is accessible by host (712) and it includes both volatile and non-volatile media, removable and non-removable media.

Memory (728) can include computer system readable media in the form of volatile memory, such as random access memory (RAM) (730) and/or cache memory (732). By way of example only, storage system (734) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (718) by one or more data media interfaces.

Program/utility (740), having a set (at least one) of program modules (742), may be stored in memory (728) by way of example, and not limitation, as well as an operating system, one or more application programs, other program modules, and program data. Each of the operating systems, one or more application programs, other program modules, and program data or some combination thereof, may include an implementation of a networking environment. Program modules (742) generally carry out the functions and/or methodologies of embodiments to store and analyze data. For example, the set of program modules (742) may include the modules configured as a functional unit in order to dynamically reconfigure the presentation of a message system as described in FIGS. 1-6C.

Host (712) may also communicate with one or more external devices (714), such as a keyboard, a pointing device, etc.; a display (724); one or more devices that enable a user to interact with host (712); and/or any devices (e.g., network card, modem, etc.) that enable host (712) to communicate with one or more other computing devices. Such communication can occur via Input/Output (I/O) interface(s) (722). Still yet, host (712) can communicate with one or more networks such as a local area network (LAN), a general wide area network (WAN), and/or a public network (e.g., the Internet) via network adapter (720). As depicted, network adapter (720) communicates with the other components of host (712) via bus (718). In one embodiment, a plurality of nodes of a distributed file system (not shown) is in communication with the host (712) via the I/O interface (722) or via the network adapter (720). It should be understood that although not shown, other hardware and/or software components could be used in conjunction with host (712). Examples, include, but are not limited to: microcode, device drivers, redundant processing units, external disk drive arrays, RAID systems, tape drives, and data archival storage systems, etc.

In this document, the terms “computer program medium,” “computer usable medium,” and “computer readable medium” are used to generally refer to media such as main memory (728), including RAM (730), cache (732), and storage system (734), such as a removable storage drive and a hard disk installed in a hard disk drive.

Computer programs (also called computer control logic) are stored in memory (728). Computer programs may also be received via a communication interface, such as network adapter (720). Such computer programs, when run, enable the computer system to perform the features of the present embodiments as discussed herein. In particular, the computer programs, when run, enable the processing unit (716) to perform the features of the computer system. Accordingly, such computer programs represent controllers of the computer system.

The present embodiments may be a system, a method, and/or a computer program product. The computer program product may include a computer readable storage medium (or media) having computer readable program instructions thereon for causing a processor to carry out aspects of the present embodiments.

The computer readable storage medium can be a tangible device that can retain and store instructions for use by an instruction execution device. The computer readable storage medium may be, an electronic storage device, a magnetic storage device, an optical storage device, an electromagnetic storage device, a semiconductor storage device, or any suitable combination of the foregoing. A list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

A computer readable signal medium includes a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium is any computer readable medium that is not a computer readable storage medium and that can communicate, propagate, or transport a program for use by or in connection with an instruction execution system, apparatus, or device.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiments.

In one embodiment, host (712) is a node of a cloud computing environment. As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Example of such characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher layer of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some layer of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

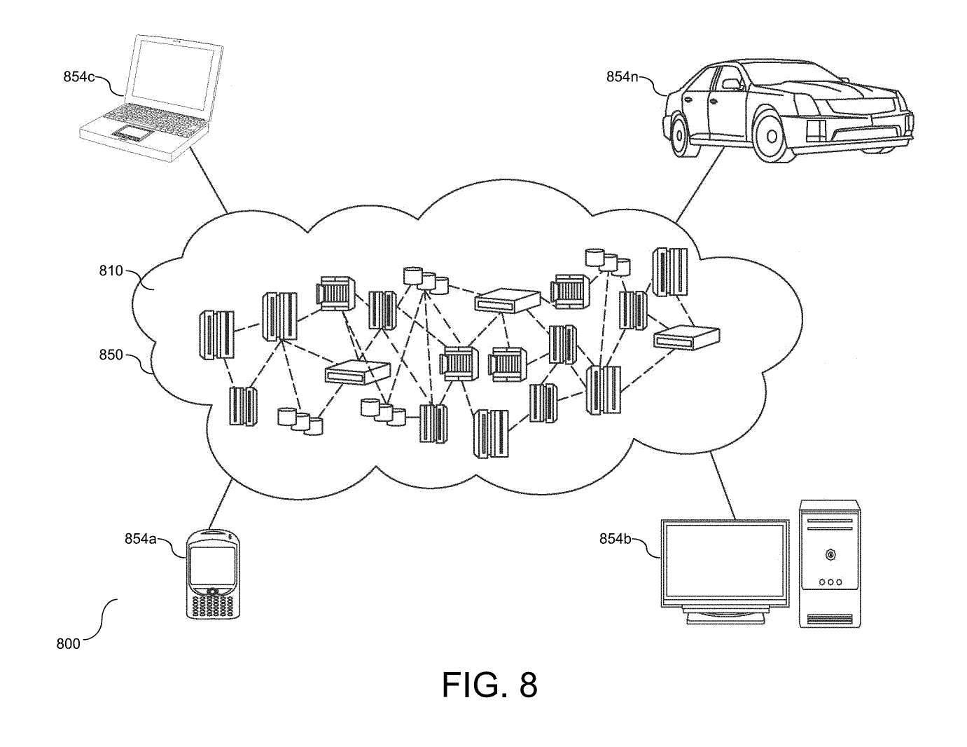

Referring now to FIG. 8, an illustrative cloud computing network (800). As shown, cloud computing network (800) includes a cloud computing environment (850) having one or more cloud computing nodes (810) with which local computing devices used by cloud consumers may communicate. Examples of these local computing devices include, but are not limited to, personal digital assistant (PDA) or cellular telephone (854a), desktop computer (854b), laptop computer (854c), and/or automobile computer system (854n). Individual nodes within nodes (810) may further communicate with one another. They may be grouped (not shown) physically or virtually, in one or more networks, such as Private, Community, Public, or Hybrid clouds as described hereinabove, or a combination thereof. This allows cloud computing environment (800) to offer infrastructure, platforms and/or software as services for which a cloud consumer does not need to maintain resources on a local computing device. It is understood that the types of computing devices (854a-n) shown in FIG. 8 are intended to be illustrative only and that the cloud computing environment (850) can communicate with any type of computerized device over any type of network and/or network addressable connection (e.g., using a web browser).

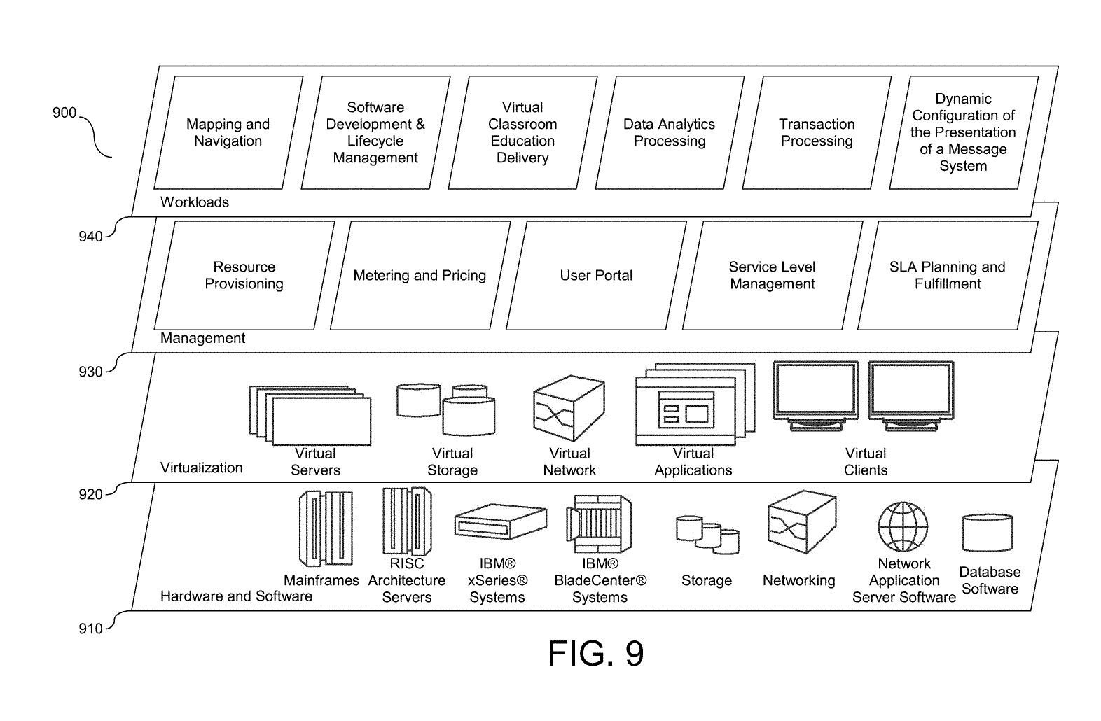

Referring now to FIG. 9, a set of functional abstraction layers (900) provided by the cloud computing network of FIG. 8 is shown. It should be understood in advance that the components, layers, and functions shown in FIG. 9 are intended to be illustrative only, and the embodiments are not limited thereto. As depicted, the following layers and corresponding functions are provided: hardware and software layer (910), virtualization layer (920), management layer (930), and workload layer (940). The hardware and software layer (910) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (920) provides an abstraction layer from which the following examples of virtual entities may be provided: virtual servers; virtual storage; virtual networks, including virtual private networks; virtual applications and operating systems; and virtual clients.

In one example, management layer (930) may provide the following functions: resource provisioning, metering and pricing, user portal, service layer management, and SLA planning and fulfillment. Resource provisioning provides dynamic procurement of computing resources and other resources that are utilized to perform tasks within the cloud computing environment. Metering and pricing provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service layer management provides cloud computing resource allocation and management such that required service layers are met. Service Layer Agreement (SLA) planning and fulfillment provides pre-arrangement for, and procurement of, cloud computing resources for which a future requirement is anticipated in accordance with an SLA.

Workloads layer (940) provides examples of functionality for which the cloud computing environment may be utilized. Examples of workloads and functions which may be provided from this layer include, but are not limited to: mapping and navigation; software development and lifecycle management; virtual classroom education delivery; data analytics processing; transaction processing; and dynamic configuration of the presentation of a message system.

As will be appreciated by one skilled in the art, the aspects may be embodied as a system, method, or computer program product. Accordingly, the aspects may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, the aspects described herein may take the form of a computer program product embodied in one or more computer readable medium(s) having computer readable program code embodied thereon.

The embodiments are described above with reference to flow chart illustrations and/or block diagrams of methods, apparatus (systems), and computer program products. It will be understood that each block of the flow chart illustrations and/or block diagrams, and combinations of blocks in the flow chart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow chart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flow chart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions, which execute on the computer or other programmable apparatus, provide processes for implementing the functions/acts specified in the flow chart and/or block diagram block or blocks.

The flow charts and block diagrams in the Figures illustrate the architecture, functionality, and operation of possible implementations of systems, methods, and computer program products according to various embodiments. In this regard, each block in the flow charts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flow chart illustration(s), and combinations of blocks in the block diagrams and/or flow chart illustration(s), can be implemented by special purpose hardware-based systems that perform the specified functions or acts, or combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The embodiments described herein may be implemented in a system, a method, and/or a computer program product. The computer program product may include a computer readable storage medium (or media) having computer readable program instructions thereon for causing a processor to carry out the embodiments described herein.

The embodiments are described herein with reference to flow chart illustrations and/or block diagrams of methods, apparatus (systems), and computer program products. It will be understood that each block of the flow chart illustrations and/or block diagrams, and combinations of blocks in the flow chart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow chart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flow chart and/or block diagram block or blocks.

It will be appreciated that, although specific embodiments have been described herein for purposes of illustration, various modifications may be made without departing from the spirit and scope of the specific embodiments described herein. Accordingly, the scope of protection is limited only by the following claims and their equivalents.

Aspects of the present embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The corresponding structures, materials, acts, and equivalents of all means or step plus function elements in the claims below are intended to include any structure, material, or act for performing the function in combination with other claimed elements as specifically claimed. The description of the present embodiments has been presented for purposes of illustration and description, but is not intended to be exhaustive or limited to the embodiments in the form disclosed.

Indeed, executable code could be a single instruction, or many instructions, and may even be distributed over several different code segments, among different applications, and across several memory devices. Similarly, operational data may be identified and illustrated herein within the tool, and may be embodied in any suitable form and organized within any suitable type of data structure. The operational data may be collected as a single dataset, or may be distributed over different locations including over different storage devices, and may exist, at least partially, as electronic signals on a system or network.

Furthermore, the described features, structures, or characteristics may be combined in any suitable manner in one or more embodiments. In the following description, numerous specific details are provided, such as examples of agents, to provide a thorough understanding of the disclosed embodiments. One skilled in the relevant art will recognize, however, that the embodiments can be practiced without one or more of the specific details, or with other methods, components, materials, etc. In other instances, well-known structures, materials, or operations are not shown or described in detail to avoid obscuring aspects of the embodiments.

The corresponding structures, materials, acts, and equivalents of all means or step plus function elements in the claims below are intended to include any structure, material, or act for performing the function in combination with other claimed elements as specifically claimed. The description of the present embodiments have been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiment was chosen and described in order to best explain the principles of the embodiments and the practical application, and to enable others of ordinary skill in the art to understand the embodiments for various embodiments with various modifications as are suited to the particular use contemplated. Accordingly, the implementation of dynamic reconfiguration of the presentation of a message system thereby provides efficient and real-time configuration of the message system to client machines or devices based on an extracted location.

It will be appreciated that, although specific embodiments have been described herein for purposes of illustration, various modifications may be made without departing from the spirit and scope of the embodiments. In particular, the dynamic reconfiguration is not restricted to a particular type of rule or parameter. In one embodiment, a parameter of the rule defines application of the rule to a physical device or element. For example, in one embodiment, one or more rules are applied to selectively permit access to messages based on location. For example, a rule is defined and applied by an administrator to prevent off-site access to one or more messages in a message system. Similarly, in one embodiment, application of the rule may physically modify configuration of a hardware element, such as hardware memory to physically support restriction of one or more electronic communications. Accordingly, the scope of protection of these embodiments is limited only by the following claims and their equivalents.

What is claimed is:

1. A computer system for dynamically filtering and configuring received data comprising:
a device, having a processing unit in communication with a memory, the device to receive at least one electronic communication for presentation on a visual display operatively coupled to the device;
at least one rule for configuring data, each rule having one or more parameters related to the presentation of electronic communications on the visual display; and
a functional tool in communication with the processing unit for dynamic configuration of data presented on the visual display, the functional tool to:
detect a condition change of the device;
in response to the detected change, identify a geographic location of the device, including extraction of the geographic location from a service local to the device;
identify a matching rule from the at least one rule based on the extracted geographic location;
dynamically apply the identified matching rule to data presented on the visual display utilizing at least one parameter of the identified matching rule, including generation of an arrangement of one or more electronic communications; and
present the generated arrangement on the visual display.

2. The system of claim 1, wherein the condition change is selected from the group consisting of: a web browser being activated, a web browser being focused, a web browser tab being focused, a message application being focused, and activation of a message application.

3. The system of claim 1, further comprising the functional unit to amend the identified matching rule including the functional unit to:
detect a change to the generated arrangement on the visual display; and
assign the detected change and the extracted geographic location as a new parameter of the identified matching rule.

4. The system of claim 1, wherein the dynamic application of the identified matching rule includes:
automated rule parameter generation including the functional unit to:
search a corpus including;
determine a company associated with the extracted geographic location; and
determine a competitor of the company; and
wherein the generation of the arrangement includes to exclude at least one message associated with the competitor.

5. The system of claim 1, wherein the electronic communications are in a message application selected from the group consisting of: a web-based electronic mail application, a locally installed email client, and a cloud-based email client.

6. The system of claim 1, wherein the dynamic application of the identified matching rule, includes the functional unit to:
receive a new electronic communication;
apply the identified matching rule to the received new electronic communication; and
selectively present the new electronic communication on the visual display based on the applied rule.

7. The system of claim 1, wherein the dynamic application of the identified matching rule, includes the functional unit to physically modify a configuration of the memory to physically support restriction of one or more electronic communications.

8. A computer program product for dynamic filtration and configuration of received data, the computer program product comprising a computer readable storage medium having program code embodied therewith, the program code executable by a processor to:
detect a condition change local to a device, the device to receive at least one electronic communication for presentation on a visual display operatively coupled to the device;
in response to the detected change, identify a geographic location of the device, including extraction of the geographic location from a service local to the device;
identify a matching rule from at least one rule for configuring data based on the extracted geographic location, each rule having one or more parameters related to presentation of electronic communications on the visual display;
dynamically apply the identified matching rule to data presented on the visual display utilizing at least one parameter of the identified matching rule, including generation of an arrangement of one or more electronic communications; and
present the generated arrangement on the visual display.

9. The computer program product of claim 8, wherein the condition change is selected from the group consisting of: a web browser being activated, a web browser being focused, a web browser tab being focused, a message application being focused and activation of a message application.

10. The computer program product of claim 8, further comprising program code to amend the identified matching rule including program code to:
detect a change to the generated arrangement on the visual display; and
assign the detected change and the extracted geographic location as a new parameter of the identified matching rule.

11. The computer program product of claim 8, wherein the dynamic application of the identified matching rule includes:
automated rule parameter generation including program code to:
search a corpus including;
determine a company associated with the extracted geographic location; and
determine a competitor of the company; and
wherein the generation of the arrangement including to exclude at least one message in the first set of messages associated with the competitor.

12. The computer program product of claim 8, wherein the dynamic application of the identified rule includes program code to:
receive a new electronic communication;
apply the identified matching rule to the received new electronic communication; and
selectively present the new message on the visual display based on the applied rule.

13. The computer program product of claim 8, wherein the dynamic application of the identified matching rule includes the program code to physically modify a configuration of a memory of the device to physically support restriction of one or more electronic communications.

14. A method for dynamical filtering and configuring of received data comprising;
detecting, by a processor in a device, a condition change local to the device, the device to receive at least one electronic communication for presentation on a visual display operatively coupled to the device;
in response to the detected change, identifying a geographic location of the device, including extracting the geographic location from a service local to the device;
identifying a matching rule from at least one rule for configuring data based on the extracted geographic location, each rule having one or more parameters related to presentation of electronic communications on the visual display;
dynamically applying the identified matching rule to data presented on the visual display utilizing at least one parameter of the identified matching rule, including generating an arrangement of one or more electronic communications; and
presenting the generated arrangement on the visual display.

15. The method of claim 14, wherein the condition change is selected from the group consisting of: a web browser being activated, a web browser being focused, a web browser tab being focused, a message application being focused, and activation of the message application.

16. The method of claim 14, further comprising amending the identified matching rule including:
detecting a change to the data presented on the visual display; and
assigning the detected change and the extracted geographic location as a new parameter of the identified matching rule.

17. The method of claim 14, wherein the dynamic application of the identified matching rule includes:
automated rule parameter generation including:
searching a corpus including;
determining a company associated with the extracted geographic location; and
determining a competitor of the company; and
wherein the generation of the arrangement includes excluding at least one message associated with the competitor.

18. The method of claim 14, wherein the electronic communications are in a message application selected from the group consisting of: a web-based electronic mail application, a locally installed email client, and a cloud-based email client.

19. The method of claim 14, wherein the dynamic application of the identified matching rule includes:
receiving, by the device, a new electronic communication;
applying the identified matching rule to the received new electronic communication; and
selectively present the new message on the visual display based on the applied rule.

20. The method of claim 14, wherein the dynamic application of the identified matching rule includes physically modifying a configuration of a memory of the device to physically support restriction of one or more electronic communications.
